(19) United States
(12) Patent Application Publication
(10) Pub. No.: US 2015/0308527 A1
(43) Pub. Date: Oct. 29, 2015

(54) TRANSMISSION DEVICE AND ELECTROMOTIVE BRAKE BOOSTER

(71) Applicant: ROBERT BOSCH GMBH, Stuttgart (DE)

(72) Inventors: Willi NAGEL, Remseck/Hochdorf (DE); Remy GARNIER, Remseck (DE)

(73) Assignee: Robert Bosch GmbH, Stuttgart (DE)

(21) Appl. No.: 14/650,219

(22) PCT Filed: Oct. 23, 2013
(86) PCT No.: PCT/EP2013/072122

§ 371 Date: Jun. 5, 2015

(30) Foreign Application Priority Data
Dec. 12, 2012 (DE) 10 2012 222 949.3

(51) Int. Cl. F16D 65/16; F16H 19/04

(52) U.S. Cl. CPC F16D 65/16; F16H 19/04; F16D 2121/24

(57) ABSTRACT

A transmission device, for example of an electromotive brake booster, includes a first worm gear and a first pinion connected to each other and rotatable about a shared first rotation axis, a second worm gear and a second pinion connected to each other and rotatable about a shared second rotation axis, a worm shaft that can be set into rotation by an electric motor and that is contacted by the first and second worm gears, a piston that is adjustable along an adjustment axis by rotations of the first pinion about the first rotation axis and the second pinion about the second rotation axis and that is guided in a floating manner to be adjustable perpendicularly to the adjustment axis by a floating travel of at least 0.6 mm.

### FIELD OF THE INVENTION

The present invention relates to a transmission device. In addition, the present invention relates to an electromotive brake booster.

### BACKGROUND

A power transmission assembly is described in DE 10 2009 027 468 A1. The power transmission assembly includes a drive, a worm shaft connected to the drive, two worm gears, which mesh with the worm shaft, and two pinions, each of which is rotatable together with an associated worm gear of the two worm gears. In addition, the power transmission assembly includes a double toothed element having a first row of teeth and a second row of teeth, each of which meshes with one of the two pinions.

### SUMMARY

The present invention makes a transmission device possible, the static and dynamic tolerances (the tolerance chain) of which can be compensated for without tensioning of the transmission device. The static tolerances are, for example, those that arise after assembly of the transmission and/or that do not change during an operation of the transmission device. Such static tolerances are, for example, an angular offset between the worm gear and the toothing of the pinion and/or an axial offset between the two toothed racks formed on the adjustable piston, which mesh with the two pinions. Dynamic tolerances are, for example, those that take effect during an operation of the transmission device and/or are a function of the actuating travel of the transmission device. Such dynamic tolerances can, for example, be concentricity deviations and pitch errors of all involved tooth gears, worms and/or toothed racks. The present invention is therefore reliably suited for eliminating functional impairments that traditionally occur in a transmission.

At the same time, two load paths are formed on the transmission device so that an advantageous power split occurs. The power split results in a compact transmission that is able to transfer comparatively high forces. As explained below in greater detail, in an example embodiment, undesirable partial meshing forces in the transmission device from the two engagements between the two pinions and the toothed racks associated with them cancel each other out in such a way that only one force oriented in a desired adjustment direction of the adjustable piston is exerted on the piston. This effectuates an advantageous, excellent adjustability of the adjustable piston in the desired adjustment direction.

The adjustable piston is preferably adjustable perpendicularly to the adjustment axis by a floating travel of at least 0.8 mm. The static and dynamic tolerances described above can, given such a large floating travel, be reliably compensated for without tensioning of the transmission device.

In particular, the adjustable piston can be guided in a floating manner between the first pinion and the second pinion in such a way that a center distance offset of at least ±0.3 mm is formed between the first pinion and the adjustable piston and between the second pinion and the adjustable piston. A center distance offset of ±0.3 mm in this case means that from the “initial position” of the pinion teeth and toothed rack teeth on block, the two sets of teeth are spaced 0.3 mm apart from each other. This results in a backlash, which is significantly greater than in the case of a conventional meshing configuration having a center distance offset of ±0.1 mm.

A center distance offset of at least ±0.4 mm can also be formed between the first pinion and the adjustable piston and between the second pinion and the adjustable piston. The advantageous formation of the comparatively large floating travel on both sides of the adjustable piston perpendicular to the adjustment axis allows for the advantageous compensation of tolerances with no additional components and with no additional installation space requirement.

In one advantageous example embodiment, a pinion center plane is definable, which intersects centrically the first pinion and the second pinion, respectively, the adjustable piston being guided in a floating manner in the pinion center plane exclusively with the aid of a first tooth engagement of the first pinion with a first row of teeth of the adjustable piston, and with the aid of a second tooth engagement of the second pinion with a second row of teeth of the adjustable piston. As explained in greater detail below, this permits an advantageous self-adjustment of the adjustable piston in a central position relative to the two pinions.

In addition, a first coverage of the first tooth engagement can be greater than or equal to 1 or a second coverage of the second tooth engagement can be greater than or equal to 1. In particular, the first coverage of the first tooth engagement can be greater than or equal to 1.05 or the second coverage of the second tooth engagement can be greater than or equal to 1.05. In this way, an overloading of the toothing and an uneven toothing sequence can be avoided.

In one preferred example embodiment, a function of a force balance is formed on the transmission device. Due to the thus implementable automatic self-adjustment of the adjustable piston, the tension-free action of the transmission device is ensured during its entire operation.

The above enumerated advantages are also ensured in the case of an electromotive brake booster including such a transmission device, whose adjustable piston is designed as a booster piston.

In one advantageous refinement of an example embodiment, the adjustable piston designed as a booster piston is guided with the aid of a radial clearance in at least one guide plane oriented at an angle to the pinion center plane in a housing bore of a brake booster housing of the electromechanical brake booster. A design including thrust surfaces on the brake booster housing suitable for this purpose can be easily implemented.

Additional features and advantages of the present invention are explained below with reference to the figures.

### BRIEF DESCRIPTION OF THE DRAWINGS

FIGS. 1a-1e show schematic general and partial representations of an example embodiment of a transmission device.

FIGS. 2a-2c show partial representations of various transmissions, FIG. 2a showing an example transmission according to the embodiment of FIGS. 1a-1e and FIGS. 2b and 2c showing other transmissions for comparison.

### DETAILED DESCRIPTION

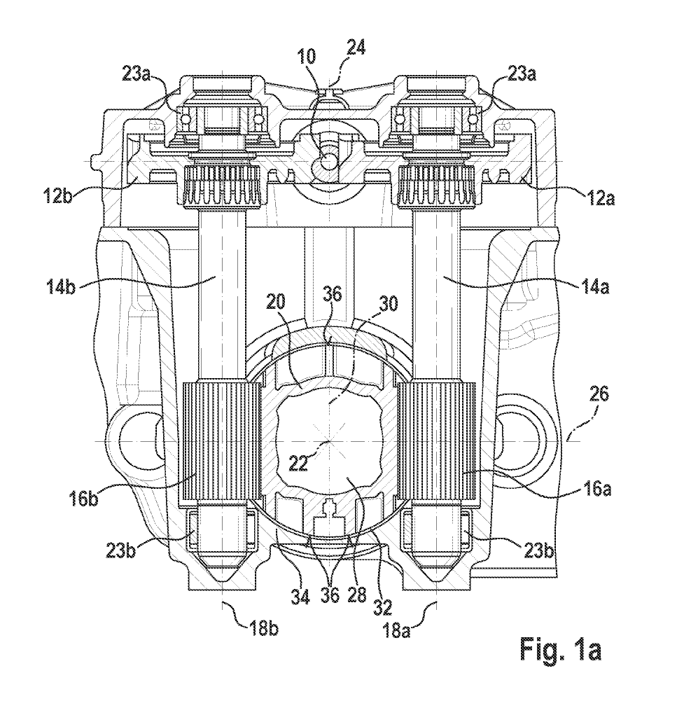

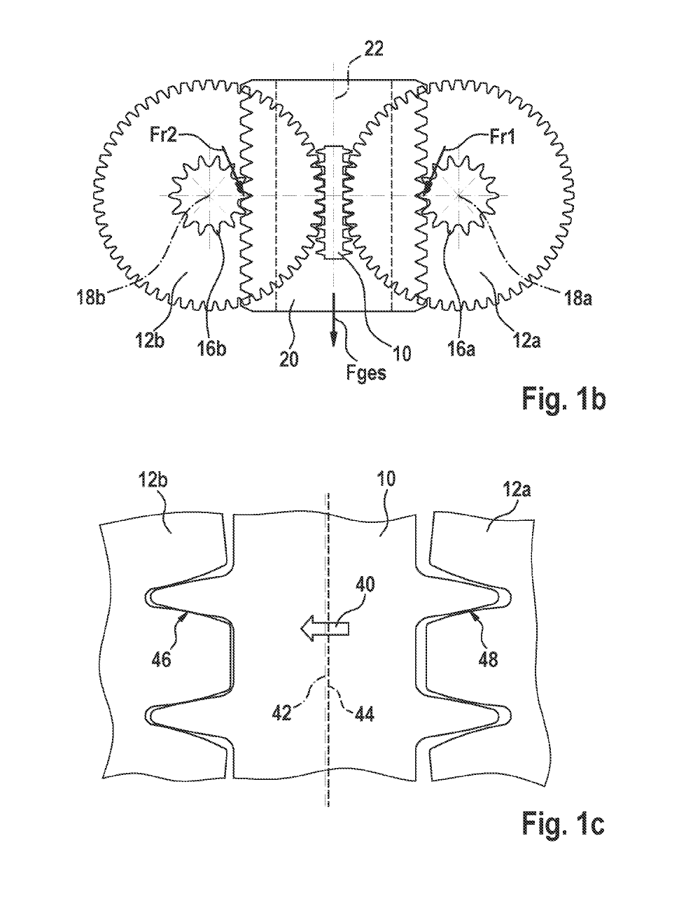

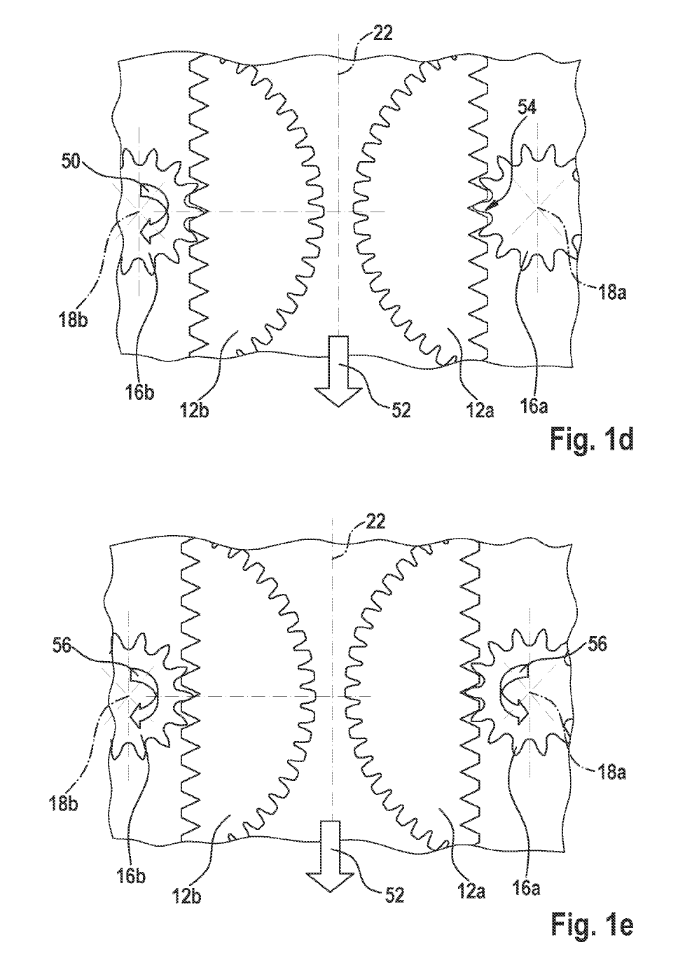

FIGS. 1a-1e show general and partial representations of a transmission device according to an example embodiment of the resent invention.

The transmission device depicted schematically in FIG. 1a includes a worm shaft 10, which is connectable to an electric motor (not depicted) in such a way that worm shaft 10 can be set into rotation about a longitudinal axis of worm shaft 10 with the aid of the electric motor. (In FIG. 1a, the longitudinal axis of worm shaft 10 is oriented perpendicularly to the image plane.) The electric motor, with the aid of which worm shaft 10 can be set into rotation about its longitudinal axis, can be a transmission-internal electric motor or an external electric motor.

In addition, the transmission device includes a first worm gear 12a, which is connected to a first pinion 16a via a first pinion shaft 14a. A second worm gear 12b of the transmission device is connected to a second pinion 16b via a second pinion shaft 14b. First worm gear 12a and second worm gear 12b contact worm shaft 10 in such a way that, with the aid of worm shaft 10 set into rotation about its longitudinal axis, first worm gear 12a and first pinion 16a are rotatable about a shared first rotation axis 18a, and second worm gear 12b and second pinion 16b are rotatable about a shared second rotation axis 18b. First rotation axis 18a and second rotation axis 18b are preferably aligned in parallel to each other. First rotation axis 18a and/or second rotation axis 18b can, in particular, be aligned perpendicularly to the longitudinal axis of worm shaft 10. However, the design of the transmission device is not limited to a particular alignment of the longitudinal axis of worm shaft 10 or of rotation axes 18a and 18b relative to each other.

The transmission device also includes an adjustable piston 20, which is guided in a floating manner between first pinion 16a and second pinion 16b. Adjustable piston 20 is adjustable along an adjustment axis 22 with the aid of first pinion 16a rotated about first rotation axis 18a and of second pinion 16b rotated about second rotation axis 18b. The adjustable piston is preferably adjustable by at least 0.5 cm along adjustment axis 22. Adjustment axis 22 of adjustable piston 20 can, in particular, be aligned in parallel to the longitudinal axis of worm shaft 10, perpendicular to first rotation axis 18a and/or perpendicular to second rotation axis 18b. (In FIG. 1a, adjustment axis 22 is aligned perpendicularly to the image plane). The alignment of adjustment axis 22 can also differ from this specific embodiment. In addition, adjustable piston 20 is guided in a floating manner between first pinion 16a and second pinion 16b in such a way that adjustable piston 20 is adjustable perpendicularly to adjustment axis 22 by a floating travel of at least 0.6 mm.

The floating travel of at least 0.6 mm of adjustable piston 20 perpendicular to adjustment axis 22 means that sufficient free space is formed between the two pinions 16a and 16b, so that adjustable piston 20 situated a minimal distance from first pinion 16a is able to float by at least 0.6 mm perpendicularly to adjustment axis 22 in the direction of second pinion 16b; and so that adjustable piston 20 situated a minimal distance from second pinion 16b can be moved toward first pinion 16a by a floating travel of at least 0.6 mm perpendicularly to adjustment axis 22. Adjustable piston 20 is therefore free for being guided perpendicularly to adjustment axis 22 in an adjustment movement between pinions 16a and 16b.

The floating travel preferably includes free space besides for that which allows for a potential heat expansion and/or swelling of adjustable piston 20 and/or pinions 16a and 16b due to absorption of liquid. Thus, the floating travel of adjustable piston 20 of at least 0.6 mm perpendicular to its adjustment axis 22 preferably still exists, even when operating the transmission device in an environment with a maximal onset temperature of the transmission device and/or when adjustable piston 20 and/or pinions 16a and 16b are in contact with liquid or air moisture for several days/weeks/months.

The comparatively free guidance of adjustable piston 20 between the two pinions 16a and 16b with a floating travel of at least 0.6 mm aligned perpendicularly to adjustment axis 22 ensures an advantageous ability to compensate for static and/or dynamic tolerances of the tolerance chain of the transmission device without tensioning. Static tolerances are identifiable as tolerances which arise after assembly of the transmission. In particular, tolerances that do not change during an operation of the transmission device can be described as static tolerances. The static tolerances include, for example, the tolerances of the positions of roller bearings 23a of worm shaft 10 from their setpoint positions and/or the tolerances of the positions of roller bearings 23b of pinion shafts 14a and 14b from their setpoint positions. The transmission device depicted in FIG. 1a includes two roller bearings 23a for worm shaft 10 and four roller bearings 23b for pinion shafts 14a and 14b. The ability to compensate for the tolerances of roller bearings 23a and 23b with the aid of the comparatively large floating travel of adjustable piston 20 perpendicular to its adjustment axis 22 of at least 0.6 mm is, therefore, particularly advantageous. Static tolerances also remediable in this way are an angular offset between pinion toothing and worm gear 12a or 12b, and/or an axial offset between the two toothed racks formed on adjustable piston 20, which mesh with the two pinions 16a and 16b.

Dynamic tolerances can be tolerances that take effect during an operation of the transmission device. In addition, dynamic tolerances can be a function of an actuating travel of the transmission device. Such dynamic tolerances can, for example, be concentricity deviations and pitch errors of the tooth gears, of the worm shaft and/or of a toothed rack. Such dynamic tolerances can also be reliably compensated for with the aid of the comparatively large floating travel of at least 0.6 mm of adjustable piston 20 perpendicular to its adjustment axis 22.

A compactness of the transmission device depicted in FIG. 1a is advantageous. In spite of the comparatively large number of components of the transmission device, the component tolerances thereof can be reliably compensated for due to the comparatively large floating travel of at least 0.6 mm. Thus, in spite of the comparatively great component tolerances, a jamming of the transmission device during an operation is reliably prevented.

As explained in greater detail below, a self-adjustment of the individual components of the transmission device during an operation is automatically implementable. The transmission device is therefore comparatively easy to assemble.

The advantages explained above can be implemented without attaching additional components to the transmission device. In addition, in a design of a floating travel of adjustable piston 20 of at least 0.6 mm aligned perpendicularly to adjustment axis 22, there are no additional installation space requirements for compensating for the tolerances of the tolerance chain of the transmission device.

In the transmission device, the first worm gear 12a and the first pinion 16a can be situated at a first distance from a definable center plane 24, which centrically intersects worm shaft 10, the distance being (virtually) the same as a second distance of second worm gear 12b and of second pinion 16b from center plane 24. Thus, the transmission device can be (virtually) symmetrically designed with respect to center plane 24 extending centrically through worm shaft 10. In particular, adjustable piston 20 (present in a center position between the two pinions 16a and 16b) can also be symmetrically designed with respect to center plane 24. This ensures an advantageous power split of the power generated by the electric motor via a first path along first worm gear 12a and first pinion 16a and along a second path via second worm gear 12b and second pinion 16b. As a result of this power split, comparatively high forces can be transmitted by the electric motor to adjustable piston 20. However, the transmission device is not limited to such a symmetrical design.

In one advantageous example embodiment of the transmission device, adjustable piston 20 is guided in a floating manner between first pinion 16a and second pinion 16b, such that a center distance offset of at least ±0.3 mm is formed between first pinion 16a and adjustable piston 20, and between second pinion 16b and adjustable piston 20, respectively. The advantageous floating travel of at least 0.6 mm can thus be formed via a backlash. Preferably, the two pinions 16a and 16b are designed symmetrically with respect to their backlash. This results in an advantageous power split in spite of the comparatively large floating travel of adjustable piston 20 of at least 0.6 mm perpendicular to its adjustment axis 22.

In one advantageous example refinement, adjustable piston 20 can be adjustable perpendicularly to adjustment axis 22 by a floating travel of at least 0.8 mm, preferably of at least 0.9 mm, in particular, of at least 1.0 mm. This is implemented in a preferred manner by guiding adjustable piston 20 in a floating manner between first pinion 16a and second pinion 16b in such a way that a center distance offset of at least ±0.4 mm, preferably of at least ±0.45 mm, in particular of at least ±0.5 mm, is formed between first pinion 16a and adjustable piston 20, and between second pinion 16b and adjustable piston 20, respectively. This permits a reliable implementation of the advantages described above.

Adjustable piston 20 is preferably guided in a floating manner between the two pinions 16a and 16b in such a way that the maximal floating travel of adjustable piston 20 perpendicular to adjustment axis 22 is less than 1.3 mm, in particular less than 1.2 mm, preferably less than 1.1 mm. A value range for the maximum floating travel of adjustable piston 20 perpendicular to adjustment axis 22 of between 0.8 mm to 1 mm is preferred. The advantages of a limitation of the maximum floating travel of adjustable piston 20 perpendicular to adjustment axis 22 will also be explained below.

In addition, a pinion center plane 26 is also definable for the transmission device in FIG. 1a, which centrically intersects first pinion 16a and second pinion 16b, respectively. (Pinion center plane 26 can be aligned perpendicularly to first rotation axis 18a and/or second rotation axis 18b.) Preferably, adjustable piston 20 is guided in a floating manner in pinion center plane 26 exclusively with the aid of a first tooth engagement of first pinion 16a with a first row of teeth (not depicted) of adjustable piston 20, and with the aid of a second tooth engagement of second pinion 16b with a second row of teeth (not depicted) of adjustable piston 20. This can also be described in that adjustable piston 20 is guided or centered in pinion center plane 26, not by a wall of a housing bore, but rather via the tooth engagements of the two pinions 16a and 16b. Thus, the maximum possible floating travel of adjustable piston 20 perpendicular to its adjustment axis 22 in pinion center plane 26 is defined via the stop of first pinion 16a on the first row of teeth and the stop of second pinion 16b on the second row of teeth. The maximum possible floating travel of adjustable piston 20 perpendicular to its adjustment axis 22 can, therefore, be comparatively precisely established in a simple manner. Alternatively or in addition thereto, adjustable piston 20 can also be guided within a guide in 2 dimensions via a raised contour formed on the exterior of the piston 20.

Preferably, a first coverage of the first tooth engagement (of first pinion 16a on the first row of teeth of adjustable piston 20) is greater than or equal to 1 or a second coverage of the second tooth engagement (of second pinion 16b on the second row of teeth of adjustable piston 20) is greater than or equal to 1. In particular, the first coverage of the first tooth engagement can be greater than or equal to 1.05 or the second coverage of the second tooth engagement can be greater than or equal to 1.05. Thus, the advantageously large floating travel of adjustable piston 20 perpendicular to adjustment axis 22 can be formed via the backlash of the two pinions 16a and 16b (or the rows of teeth associated with them). In this way, advantageously large distance tolerances can be formed for compensating for the above described tolerance chain. With the coverages of at least 1, an excessively high tooth stress of the teeth of pinions 16a and 16b and of the rows of teeth of adjustable piston 20 is prevented. In this way, an advantageously long service life/operating time of the transmission device may be ensured.

The transmission device depicted in FIG. 1a is designed as a subunit of an electromotive brake booster, adjustable piston 20 being designed as a booster piston (booster). That is, adjustable piston 20 can interact with an input rod (not depicted) in such a way that a driver braking force transmitted via the input rod is transmittable together with a force of the electric motor to at least one main brake cylinder piston. For example, a continuous center bore 28 can be formed in adjustable piston 20, through which the input rod can be guided. The design of the transmission device as a subunit of an electromotive brake booster is merely exemplary.

Also merely exemplary is the guiding of adjustable piston 20 designed as a booster piston in at least one guide plane 30 aligned at an angle, in particular, perpendicularly, to pinion center plane 26, with the aid of a radial clearance, which is formed via the thrust surfaces 36 in a housing bore 32 of a brake booster housing 34. The design of thrust surfaces 36 on housing bore 32 permits a reliable guiding of adjustable piston 20 designed as a booster piston, but it is not required.

A force balance is formed in the transmission device of FIG. 1a. This is explained below with reference to FIGS. 1b-1e.

In FIG. 1b, meshing forces Fr1 and Fr2 are exerted on adjustable piston 20 with the aid of pinions 16a and 16b. A first meshing force Fr1 is exertable on adjustable piston 20 by first pinion 16a rotated about first rotation axis 18a, and a second meshing force Fr2 is exertable on adjustable piston 20 by second pinion 16b rotated about second rotation axis 18b. This can also be described in that meshing forces Fr1 and Fr2 are exerted by the tooth flanks of pinions 16a and 16b on the contacted tooth flanks (of the rows of teeth) of adjustable piston 20.

Meshing forces Fr1 and Fr2 are aligned orthogonally relative to the respective tooth flanks. If meshing forces Fr1 and Fr2 exerted on adjustable piston 20 are equally great/exhibit the same absolute values, then the components of meshing forces Fr1 and Fr2 aligned perpendicularly to adjustment axis 22 cancel each other out. In this case, meshing forces Fr1 and Fr2 add up to a total force Fges, which is aligned in parallel to adjustment axis 22. Thus, given the same meshing forces/absolute values of meshing forces Fr1 and Fr2, the desired linear adjustability of adjustable piston 20 along adjustment axis 22 is reliably ensured without a jamming occurring.

In the case of unequal meshing forces/absolute values of meshing forces Fr1 and Fr2, a force component aligned perpendicularly to adjustment axis 22 remains, which is directed from the high force side (of the greater meshing force Fr1 or Fr2) to the low force side (of the smaller meshing force Fr1 or Fr2). Adjustable piston 20 is moved (automatically) from the high force side to the low force side by the force component aligned perpendicularly to adjustment axis 22. In this way, the tooth engagement on the originally high force side (automatically) tends increasingly toward disengagement, so that the tooth engagement on the originally lower force side becomes stronger. In this way, adjustable piston 20 is displaced until meshing forces Fr1 and Fr2 are equally great/exhibit the same absolute values.

Thus, a force balance on the transmission device is formed in this way. This ensures a symmetrical load distribution of the force transmitted from the motor to adjustable piston 20 via a first load path implemented using a first worm gear 12a and first pinion 16a, and via a second load path implemented using a second worm gear 12b and second pinion 16b.

The tolerance compensation on the transmission device is explained in the following with reference to FIGS. 1c-1e.

In the depiction of FIG. 1c, worm shaft 10 is offset from a central position between the two worm gears 12a and 12b in direction 40 by approximately 0.1 mm. Thus, longitudinal axis 42 of worm shaft 10 shown by the dashed line is approximately 0.1 mm from its central setpoint position 44 between the two worm gears 12a and 12b. Worm shaft 10 is therefore situated closer to second worm gear 12b. In a “soft” design of components 10 and 12b, this would result in “overlap” 46 with second worm gear 12b and gap 48 between worm shaft 10 and first worm gear 12a.

Since “overlap” 46 depicted in FIG. 1c is not possible due to a compact design of components 10 and 12b, second worm gear 12b is prompted to an additional rotation 50 compared to first worm gear 12a. This additional rotation 50 of second worm gear 12b is delineated in FIG. 1d. Additional rotation 50 of second worm gear 12b is accordingly also carried out by second pinion 16b. Additional rotation 50 of second pinion 16b causes a (slight) displacement 52 of adjustable piston 20 along adjustment axis 22.

However, since the (slight) displacement 52 of adjustable piston 20 is not linked to a simultaneous rotation of first pinion 16a about first rotation axis 18a, the (slight) displacement 52 of adjustable piston 20 causes an increase of the mesh clearance between first pinion 12a and adjustable piston 20. Tooth engagement 54 between first pinion 16a and adjustable piston 20 is therefore force-free.

Meshing force Fr2, which is exerted by second pinion 16b on adjustable piston 20, is therefore not compensated for at least in part by a counterforce. The effect of this is that the force component of meshing force Fr2 aligned perpendicularly to adjustment axis 22 exerted by second pinion 16b on adjustable piston 20 causes an adjustment movement of adjustable piston 20, until a force equilibrium between meshing forces Fr1 and Fr2 is restored. Thus, the function of the force balance described above can also be utilized in order to compensate for an off-center position of worm shaft 10. The desired counter-directional rotations 56 of pinions 16a and 16b for adjusting adjustable piston 20 along its adjustment axis 22 may be implemented without a jamming Thus, the comparatively large floating travel of at least 0.6 mm results in the possibility of an axial offset of adjustable piston 20, as a result of which every tolerance chain can be compensated for.

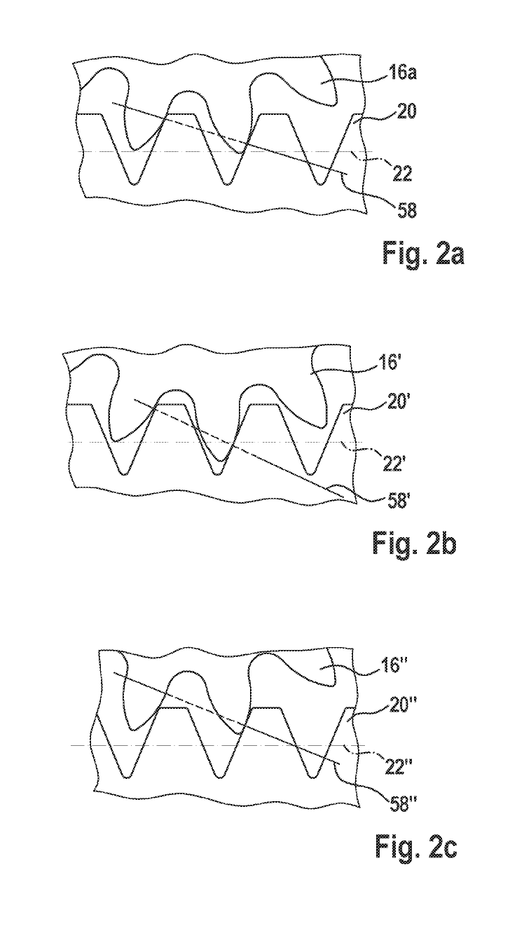

FIGS. 2a-2c show partial representations of different transmissions, FIG. 2a showing an example according to the embodiment of FIGS. 1a-1e and the transmissions of FIGS. 2b and 2c not being specific embodiments of the present invention.

It is expressly noted at this point that those skilled in the art must overcome many conventional preconceptions before they recognize the advantages of the transmission device depicted in FIG. 2a, which includes an adjustable piston 20 with a comparatively large floating travel of 0.8 mm perpendicular to its adjustment axis 22. For example, those skilled in the art generally strive for a comparatively small floating travel, since an increase of the floating travel is often associated with a deterioration of the force transmission from an electric motor to piston 20 to be adjusted.

Moreover, to ensure the comparatively large 0.8 mm floating travel of adjustable piston 20 perpendicular to its adjustment axis 22, those skilled in the art are forced to meet contradictory boundary conditions when designing the toothing of pinions 16a and 16b and the toothed racks associated with them. For the floating travel of 0.8 mm, there should be a center distance offset on pinions 16a and 16b, respectively, of ±0.4 mm. A center distance offset of ±0.4 mm may be understood to mean that from the “initial position” of pinion teeth/toothed rack teeth on block, the two sets of teeth are spaced apart by 0.4 mm from one another. This results in an oversized backlash. (A conventional toothing design usually has a center distance offset of ±0.1 mm.)

In the case of a transmission device, however, those skilled in the art generally also prefer a preferably high transmission ratio, which is why they select a diameter for pinions 16a and 16b which is often comparatively small as compared to the diameter of worm gears 12a and 12b. However, a reduction of the diameter of pinions 16a and 16b in the case of a center distance offset of ±0.4 mm (on both sides) results in a coverage of tooth engagements of less than 1, which is associated with an irregular run of the transmission and high bending stresses at the tooth base. Pinions 16a and 16b with a larger diameter increases the coverage, but results in a lower transmission ratio. The implementation of the transmission device partially depicted in FIG. 2a, therefore, requires those skilled in the art, in spite of a distance tolerance (on both sides) of 0.4 mm, to ensure a coverage of tooth engagements at least equal to 1, preferably greater than 1.

Frequently, those skilled in the art also prefer preferably large teeth on pinions 16a and 16b and on the rows of teeth. For this reason, those skilled in the art traditionally shy away from designing a floating travel of at least 0.6 mm on a transmission device.

The transmission device partially schematically depicted in FIG. 2b, which is not according to the described example embodiment of the present invention, has a maximal floating travel of approximately 0.2 mm perpendicular to an adjustment axis 22′ of its adjustable piston 20′, i.e., a center distance offset of ±0.1 mm. The coverage between the tooth engagements of the teeth of pinion 16′ and the associated row of teeth of adjustable piston 20′ is 1.5 teeth. Also depicted in FIG. 2b is force line 58′, via which the meshing force of pinion 16′ is transmitted to the teeth of the associated row of teeth of adjustable piston 20′. The absolute value of the meshing force and the distance of the point of intersection of force line 58′ on the tooth flanks of the tooth bases yields the torques which the teeth must withstand during an operation of the transmission. An operation of the transmission depicted in FIG. 2b causes a comparatively low tooth stressing of approximately 70%.

The transmission depicted schematically in FIG. 2c, which is also not a specific embodiment of the present invention, has a maximal floating travel for adjustable piston 20″ perpendicular to its adjustment axis 22″ amounting to 1.3 mm. The center distance offset is therefore ±0.65 mm. The coverage is merely at a value of 0.75 of a tooth. This results in force line 58″ depicted in FIG. 2c and, therefore, in a stressing of the tooth base of 140%. Hence, an operation of the transmission of FIG. 2c causes a rapid breaking of the teeth. Moreover, the transmission device of FIG. 2c exhibits an irregular run due to the relatively large floating travel of 1.3 mm.

Thus, when developing the transmission device, those skilled in the art must solve the problem that an excessively large floating travel may result in a significant decrease of the coverage, as a result of which the tooth stressing increases sharply. Those skilled in the art must overcome multiple difficulties in order to arrive at the transmission depicted in FIG. 2a. In the transmission depicted in FIG. 2a, adjustable piston 20 is guided in a floating manner between first pinion 16a and second pinion 16b (not depicted) in such a way that adjustable piston 20 is adjustable perpendicularly to its adjustment axis 22 by a floating travel of 0.8 mm. This is implemented by a center distance offset on both sides of ±0.4 mm. The coverage of the first tooth engagement is maximal 1.05 teeth. This results in the advantageous force line 58 and a tooth stressing of 100% during an operation of the transmission of FIG. 2a. An advantageously long service life of the transmission of FIG. 2a is thereby ensured, in spite of the comparatively large floating travel of 0.8 mm.

1-10. (canceled)

11. A transmission device comprising:
a worm shaft connectable to an electric motor and rotatable about a longitudinal axis of the worm shaft under influence of the electric motor;
a first pinion;
a second pinion;
a first worm gear connected to the first pinion;
a second worm gear connected to the second pinion, wherein the first worm gear and the second worm gear contact the worm shaft such that the first worm gear and the first pinion are rotatable about a shared first rotation axis in response to rotation of the worm shaft about the longitudinal axis, and such that the second worm gear and the second pinion are rotatable about a shared second rotation axis in response to the rotation of the worm shaft about the longitudinal axis; and
a piston that is adjustable along an adjustment axis by rotations of the first pinion about the first rotation axis and the second pinion about the second rotation axis and that is guidable in a floating manner between the first pinion and the second pinion for adjustment perpendicularly to the adjustment axis by a floating travel up to at least 0.6 mm.

12. The transmission device of claim 11, wherein the floating travel up to which the piston is guidable is at least 0.8 mm.

13. The transmission device of claim 11, wherein the piston is arranged between the first and second pinions in such a way that a center distance offset of at least ±0.3 mm is formed between the piston and each of the first and second pinions.

14. The transmission device of claim 11, wherein the piston is arranged between the first and second pinions in such a way that a center distance offset of at least ±0.4 mm is formed between the piston and each of the first and second pinions.

15. The transmission device of claim 11, wherein, by at least one of a first tooth engagement of the first pinion with a first row of teeth of the piston and a second tooth engagement of the second pinion with a second row of teeth of the piston, the piston is guidable in a floating manner in a pinion center plane defined by central intersection of the first and second pinions.

16. The transmission device of claim 11, wherein, exclusively by at least one of a first tooth engagement of the first pinion with a first row of teeth of the piston and a second tooth engagement of the second pinion with a second row of teeth of the piston, the piston is guidable in a floating manner in a pinion center plane defined by central intersection of the first and second pinions.

17. The transmission device of claim 16, wherein a first coverage of the first tooth engagement is at least 1, or a second coverage of the second tooth engagement is at least 1.

18. The transmission device of claim 16, wherein the first coverage of the first tooth engagement is at least 1.05, or the second coverage of the second tooth engagement is at least 1.05.

19. The transmission device of claim 11, wherein the transmission device is structured for the piston to be shifted to respond to unequal forces exerted by the first and second pinions on the piston by shifting between the first pinion and second pinions for adjustment perpendicularly to the adjustment axis, thereby balancing the forces.

20. An electromotive brake booster comprising a transmission device, the transmission device including:
a worm shaft connectable to an electric motor and rotatable about a longitudinal axis of the worm shaft under influence of the electric motor;
a first pinion;
a second pinion;
a first worm gear connected to the first pinion;
a second worm gear connected to the second pinion, wherein the first worm gear and the second worm gear contact the worm shaft such that the first worm gear and the first pinion are rotatable about a shared first rotation axis in response to rotation of the worm shaft about the longitudinal axis, and such that the second worm gear and the second pinion are rotatable about a shared second rotation axis in response to the rotation of the worm shaft about the longitudinal axis; and
a booster piston that is adjustable along an adjustment axis by rotations of the first pinion about the first rotation axis and the second pinion about the second rotation axis and that is guidable in a floating manner between the first pinion and the second pinion for adjustment perpendicularly to the adjustment axis by a floating travel up to at least 0.6 mm.

21. The electromotive brake booster of claim 20, wherein the booster piston is guidable in a guide plane with a radial clearance in a housing bore of a brake booster housing of the electromechanical brake booster, the guide plane being angularly offset from a pinion center plane that is defined by central intersection of the first and second pinions.
